(19) United States
(12) Patent Application Publication
(10) Pub. No.: US 2017/0103366 A1
(43) Pub. Date: Apr. 13, 2017

(54) DATA ENTRY PROCESSOR

(71) Applicant: Accenture Global Services Limited, Dublin (IE)

(72) Inventors: Vivek GUPTA, Delhi (IN); Deepak Aggarwal, Delhi (IN); Shipra Kakkar, Haryana (IN); Shekar Nalle Pilli Venkateswara, Vienna, VA (US)

(21) Appl. No.: 15/291,866

(22) Filed: Oct. 12, 2016

(30) Foreign Application Priority Data
Oct. 13, 2015 (IN) 5479/CHE/2015

(51) Int. Cl. G06Q 10/10

(52) U.S. Cl. CPC G06Q 10/105; G06Q 10/1093

(57) ABSTRACT

A device may receive data from a user. The device may automatically evaluate the data to identify a set of attributes that are associated with classifying one or more data entries as being associated with a threshold risk. The device may automatically evaluate the data to generate, based on an attribute, of the set of attributes, associated with a data entry, of the one or more data entries, a recommendation associated with reducing a risk associated with the data entry, such that the risk does not exceed the threshold risk. The device may provide, to the user, information identifying the recommendation.

### RELATED APPLICATION

This application claims priority under 35 U.S.C. §119 to Indian Patent Application No. 5479/CHE/2015, filed on Oct. 13, 2015 the content of which is incorporated by reference herein in its entirety

### BACKGROUND

Employee attrition may be costly to a company, as a result of costs associated with hiring new employees, training new employees, or the like. The company may implement programs to retain employees for a workforce of the company, such as offering career development programs, executive coaching programs, orientation programs, or the like. Moreover, the company may offer employment perks, such as onsite daycare, complimentary food, flexible hours, or the like, to encourage employees to remain at the company.

### SUMMARY

According to some possible implementations, a device may include one or more processors. The one or more processors may receive data from a user. The one or more processors may automatically evaluate the data to identify a set of attributes that are associated with classifying one or more data entries as being associated with a threshold risk. The one or more processors may automatically evaluate the data to generate, based on an attribute, of the set of attributes, associated with a data entry, of the one or more data entries, a recommendation associated with reducing a risk associated with the data entry, such that the risk does not exceed the threshold risk. The one or more processors may provide, to the user, information identifying the recommendation.

According to some possible implementations, a non-transitory computer-readable medium may store instructions that, when executed by one or more processors, may cause the one or more processors to provide a user interface with which to receive information. The one or more instructions, when executed by one or more processors, may cause the one or more processors to receive, via the user interface, information associated with selecting a subset of employees of a company from which to identify one or more employees at risk of attrition. The one or more instructions, when executed by one or more processors, may cause the one or more processors to obtain employee information regarding employees of the company. The one or more instructions, when executed by one or more processors, may cause the one or more processors to filter the employee information to select a subset of employee information relating to the subset of employees of the company. The one or more instructions, when executed by one or more processors, may cause the one or more processors to identify the one or more employees at risk of attrition based on the subset of employee information. The one or more employees at risk of attrition may be determined to be associated with a risk of attrition that satisfies a threshold risk. The one or more instructions, when executed by one or more processors, may cause the one or more processors to generate, for each employee of the one or more employees at risk of attrition, a corresponding recommendation for reducing the risk of attrition. The one or more instructions, when executed by one or more processors, may cause the one or more processors to provide, via the user interface, information identifying, for a particular employee of the one or more employees, the corresponding recommendation for reducing the risk of attrition.

According to some possible implementations, a method may include determining, by a device, a set of drivers of attrition associated with a workforce of a company. Each driver of attrition, of the set of drivers of attrition, may be associated with a threshold likelihood of attrition for an employee. The method may include receiving, by the device, information identifying a portion of the workforce of the company from which to identify one or more employees at risk of attrition. The portion of the workforce may be less than the workforce. The method may include identifying, by the device, a particular employee of the portion of the workforce of the company associated with a driver of attrition of the set of drivers of attrition. The method may include determining, by the device, that the particular employee is associated with a likelihood of attrition that satisfies a threshold likelihood. The method may include determining, by the device, a plurality of recommendations associated with reducing the likelihood of attrition for the particular employee such that the likelihood of attrition does not satisfy the threshold likelihood. The method may include selecting, by the device, a particular recommendation of the plurality of recommendations. The method may include providing, by the device, information identifying the particular recommendation.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for automatically identifying employees at risk of attrition and providing information associated with increasing a likelihood of retaining the employees at risk of attrition; and

FIGS. 5A-5D are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

Employee attrition (e.g., employees that leave a company for retirement, for another job, for negative job satisfaction, etc.) may result in increased costs for a company. For example, the company may need to hire and train new employees to replace employees that leave the company. The company may utilize one or more employee retention strategies to reduce a likelihood that employees leave the company. For example, the company may offer training programs, advancement opportunities, holiday bonuses, or the like. Additionally, or alternatively, the company may offer fringe benefits, such as subsidized meals, daycare services, entertainment programs, or the like.

However, utilizing company-wide programs to reduce employee attrition may be costly, and may be poorly targeted to at-risk employees (e.g., employees associated with a risk of attrition that exceeds a threshold risk). Implementations, described herein, may leverage information collected by a company regarding the company's employees to automatically identify at-risk employees and provide recommendations of one or more employee retention strategies targeted to the at-risk employees. In this way, an employee attrition rate is reduced relative to a company that does not implement the one or more retention strategies, thereby reducing costs associated with hiring and training replacement employees. Moreover, costs associated with implementing the one or more employee retention strategies targeted to the at-risk employees is reduced relative to implementing a company-wide retention program. Furthermore, based on to generating recommendations targeted to at-risk employees based on information associated with the at-risk employees rather than based on information associated with all employees of the company reduces memory and/or processing requirements.

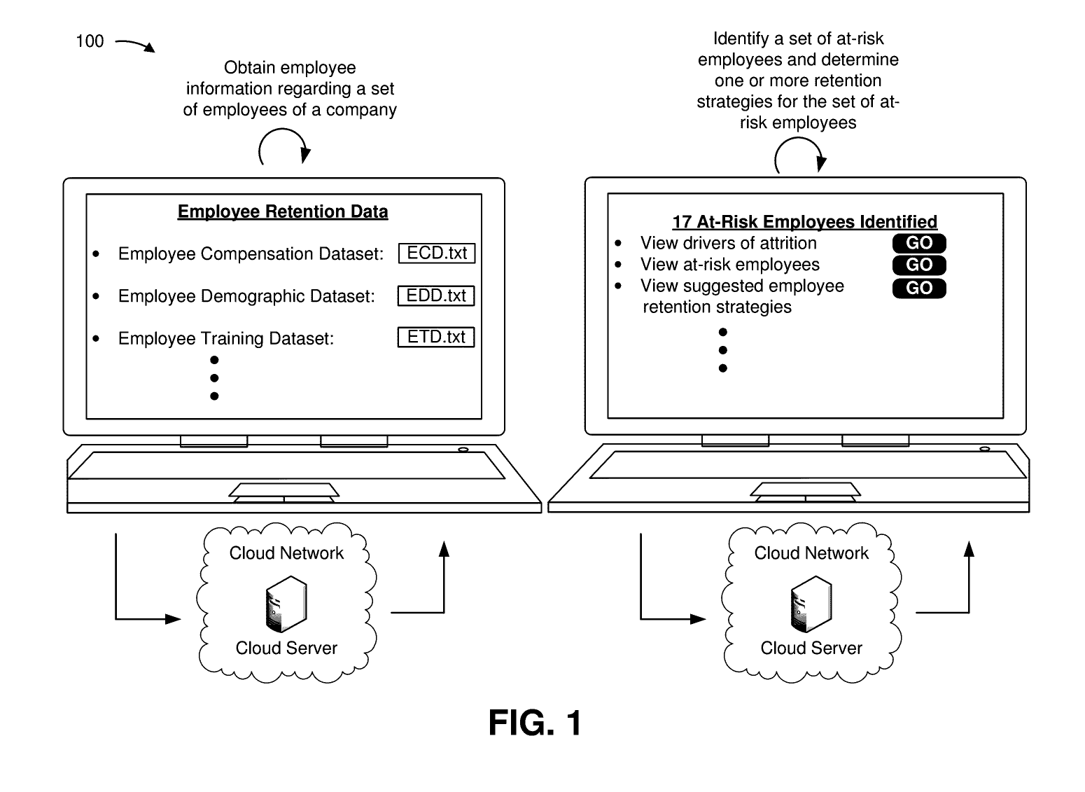

FIG. 1 is a diagram of an overview of an example implementation 100 described herein. As shown in FIG. 1, a cloud server may cause a user device to provide a user interface to input employee information (e.g., data) associated with a set of employees of a company (e.g., who may be identified by data entries of the data). For example, a user may provide, via the user interface, information identifying one or more datasets storing employee information associated with the set of employees, such as compensation information, demographic information (e.g., an age of an employee, a gender of an employee, an ethnicity of an employee, etc.), training information (e.g., a level of education of an employee, a set of training certifications possessed by an employee, a set of training programs attended by an employee, etc.), or the like. Additionally, or alternatively, the user may provide information identifying other datasets storing employee information associated with the set of employees, such as information identifying years with the company, status of employment (e.g., part time, full time, etc.), job position (e.g., manager, supervisor, entry-level, hourly, salaried, etc.), or the like.

In another example, the cloud server may receive other employee information, such as information regarding a set of former employees that have left the company, information regarding a human resources performance evaluation of a particular employee, or the like. In another example, the cloud server may automatically obtain employee information, such as by automatically locating one or more data structures storing employee information, automatically generating a survey and providing the survey to and receiving survey results from a set of employees, or the like. In another example, the cloud server may parse information to obtain the employee information, such as parsing a human resources report, a press release, a news article, or the like (e.g., using natural language processing, machine learning, etc.). In this way, the cloud server reduces computing utilization relative to a user being required to manually provide employee information.

The cloud server may process the employee information to determine one or more drivers of attrition. A driver of attrition may refer to an attribute of an employee that corresponds to a likelihood of attrition that exceeds a threshold likelihood. For example, based on information regarding vacation time utilized by employees, the cloud server may determine that utilization of over 90% of offered vacation time corresponds to a likelihood of attrition that exceeds the threshold likelihood. The cloud server may identify a set of at-risk employees based on the one or more drivers of attrition. For example, the cloud server may determine that a particular employee is associated with the attribute of utilizing over 90% of offered vacation time (e.g., a driver of attrition), and may classify the particular employee as an at-risk employee. In this way, the cloud server identifies at-risk employees based on attributes of the at-risk employees being drivers of attrition that correspond to a threshold likelihood of attrition.

In another example, the cloud server may process a portion of the employee information. For example, the cloud server may identify, based on a set of filtering criteria, a subset of employees of interest when determining the at-risk employees and/or a subset of attributes of interest when determining the drivers of attrition. In this case, the cloud server may process employee information relating to the employees of interest, the subset of attributes, or the like. In this way, cloud server reduces processing and/or memory utilization relative to processing all employee information.

The cloud server may determine one or more employee retention strategies targeted to the set of at-risk employees based on the employee information, the one or more drivers of attrition, or the like. An employee retention strategy may refer to a strategy that corresponds to a threshold reduction in a likelihood of attrition for an at-risk employee. For example, the cloud server may determine that for employees associated with the attribute of utilizing over 90% of offered vacation time, an employee retention strategy of increasing salary by a particular percentage corresponds to a threshold reduction in a likelihood of attrition. In this case, the cloud server may select the employee retention strategy of increasing salary by the particular percentage for at-risk employees associated with the attribute of utilizing over 90% of offered vacation time.

In another example, for another at-risk employee associated with an attribute of being required to travel for work greater than a threshold percentage of time, the cloud server may determine an employee retention strategy of offering a teleworking option to reduce a likelihood of attrition. In this case, the cloud server may select the employee retention strategy of offering a teleworking option for the other at-risk employee. In this way, the cloud server selects one or more employee retention strategies targeted to a particular driver of attrition that causes a particular employee to be classified as an at-risk employee. Based on determining employee retention strategies targeted to each at-risk employee of the company (e.g., a subset of employees of the company), the cloud server may reduce processing resources, memory resources, or the like relative to determining employee retention strategies for all employees of the company.

As further shown in FIG. 1, the cloud server may cause the user device to provide information associated with employee retention. For example, the user device may provide, via the user interface, information identifying the one or more drivers of attrition, information identifying the set of at-risk employees, information identifying the one or more employee retention strategies associated with reducing a risk of attrition for the set of at-risk employees, or the like. In another example, the cloud server may automatically generate and populate a set of calendar entries. For example, when the cloud server determines to offer a particular educational program to a particular at-risk employee, the cloud server may automatically cause a calendar utilized by the particular at-risk employee to include the particular education program.

In another example, the cloud server may automatically update a compensation data structure. For example, when the cloud server determines that a set of at-risk employees are to receive pay raises, the cloud server may automatically cause an accounting data structure to include the pay raises for the set of at-risk employees. In another example, the cloud server may automatically identify one or more decision-makers associated with an employee retention strategy. For example, the cloud server may identify a promotion manager associated with deciding whether to accept a recommendation to promote an at-risk employee, and may generate a decision file (e.g., information identifying the employee, the promotion, the risk of attrition, etc.) based on which the promotion manager can decide whether to accept the recommendation.

In another example, the cloud server may automatically update a company policy or digital employee handbook. For example, when the cloud server determines that an attribute of utilizing less than a particular percentage of vacation time is a driver of attrition, the cloud server may automatically update a company policy and an employee handbook to indicate that employees are required to utilize greater than the particular percentage of vacation time, thereby reducing a likelihood that an employee becomes at at-risk employee. As another example, the cloud server may automatically update the digital employee handbook to identify one or more fringe benefits being offered to the at-risk employee to reduce a likelihood of attrition.

In this way, the cloud server provides information associated with reducing a risk of attrition for employees of a company, thereby reducing costs associated with hiring and training replacement employees. Moreover, the cloud server reduces costs for a company relative to the company implementing a company-wide employee retention strategy based on targeting the one or more employee retention strategies to the set of at-risk employees rather than to all employees. Furthermore, based on filtering data to identify data regarding a particular subset of employees (e.g., at-risk employees, managerial employees, etc.), the cloud server may reduce processing and/or memory utilization relative to utilizing data regarding all employees of the company.

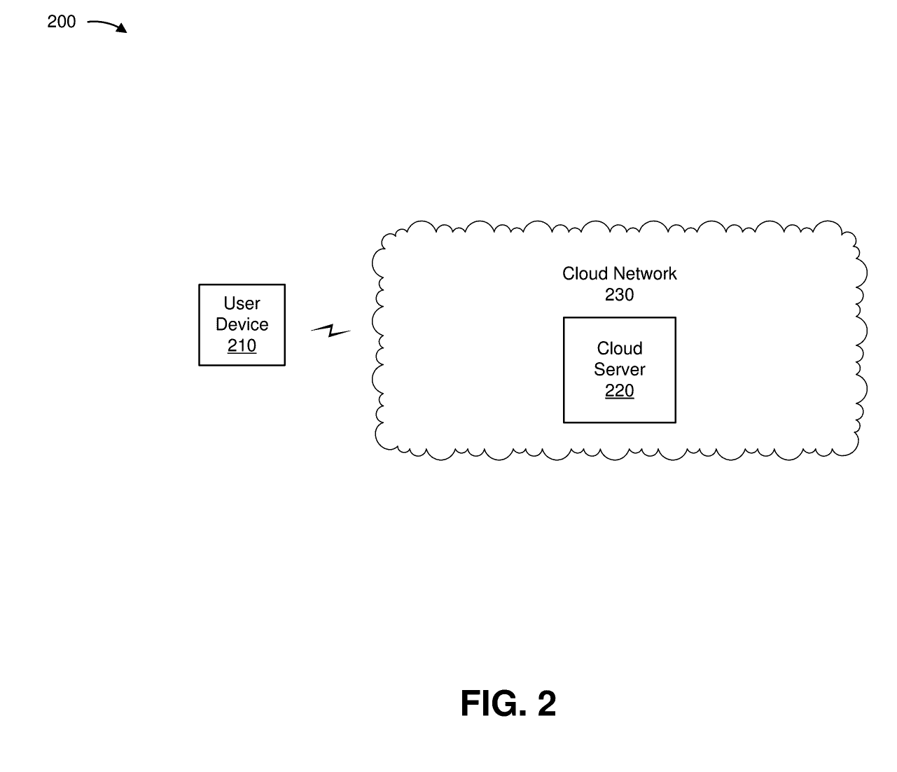

FIG. 2 is a diagram of an example environment 200 in which systems and/or methods, described herein, may be implemented. As shown in FIG. 2, environment 200 may include a user device 210, a cloud server 220, and a cloud network 230. Devices of environment 200 may interconnect via wired connections, wireless connections, or a combination of wired and wireless connections.

User device 210 may include one or more devices capable of receiving, generating, storing, processing, and/or providing information associated with employee attrition. For example, user device 210 may include a communication and/or computing device, such as a mobile phone (e.g., a smart phone, a radiotelephone, etc.), a computer (e.g., a laptop computer, a tablet computer, a handheld computer, a desktop computer, etc.), a wearable communication device (e.g., a smart wristwatch, a pair of smart eyeglasses, etc.), or a similar type of device. In some implementations, user device 210 may provide a user interface with which to input employee information associated with a set of employees of a company. In some implementations, user device 210 may receive information from and/or transmit information to another device in environment 200.

Cloud server 220 may include one or more devices capable of storing, processing, and/or routing information associated with employee attrition. For example, cloud server 220 may include a set of physical servers providing assignable computing resources, a set of virtualized servers representing the assignable computing resources, or the like. A server, as described herein, may refer to a physical server that is associated with cloud network 230, a virtualized server (e.g., a conceptual representation of computing resources that are at least partially implemented in hardware and are allocated by cloud network 120 for a particular functionality), or the like. In some implementations, cloud server 220 may determine one or more drivers of attrition and identify a set of at-risk employees based on employee information associated with a set of employees of a company. In some implementations, cloud server 220 may include stored information regarding a set of other employees of a set of other companies, and may process the stored information to determine a driver of attrition and/or identify an at-risk employee associated with an attribute corresponding to the driver of attrition. In some implementations, cloud server 220 may include a communication interface that allows cloud server 220 to receive information from and/or transmit information to other devices in environment 200. While cloud server 220 will be described as a resource in a cloud computing network, such as cloud network 230, cloud server 220 may operate external to a cloud computing network, in some implementations.

Cloud network 230 may include an environment that delivers computing as a service, whereby shared resources, services, etc. may be provided by cloud server 220 to store, process, and/or route information associated with an employment diversity plan. Cloud network 230 may provide computation, software, data access, storage, and/or other services that do not require end-user knowledge of a physical location and configuration of a system and/or a device that delivers the services (e.g., cloud server 220). As shown, cloud network 230 may include cloud server 220 and/or may communicate with user device 210 via one or more wired or wireless networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. For example, although user device 210 and cloud server 220 are shown as two separate devices, user device 210 and cloud server 220 may be implemented within a single device (e.g., a single device that utilizes cloud-based resources for a portion of processing, data storage, or the like). Additionally, or alternatively, a set of devices (e.g., one or more devices) of environment 200 may perform one or more functions described as being performed by another set of devices of environment 200.

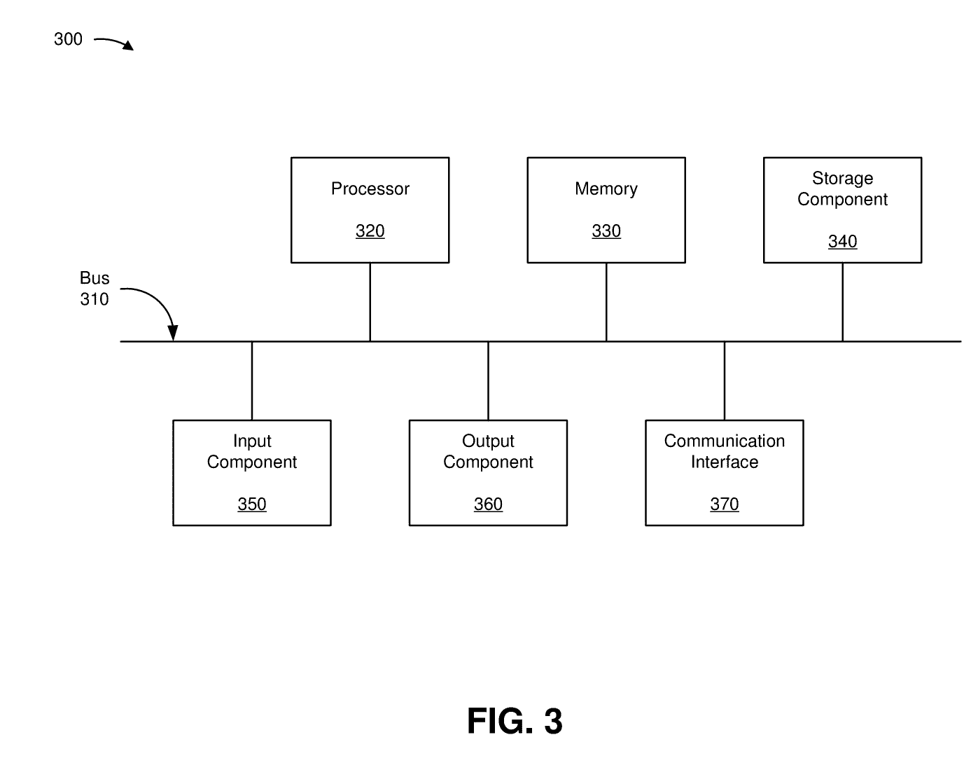

FIG. 3 is a diagram of example components of a device 300. Device 300 may correspond to user device 210 and/or cloud server 220. In some implementations, user device 210 and/or cloud server 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors that can be programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

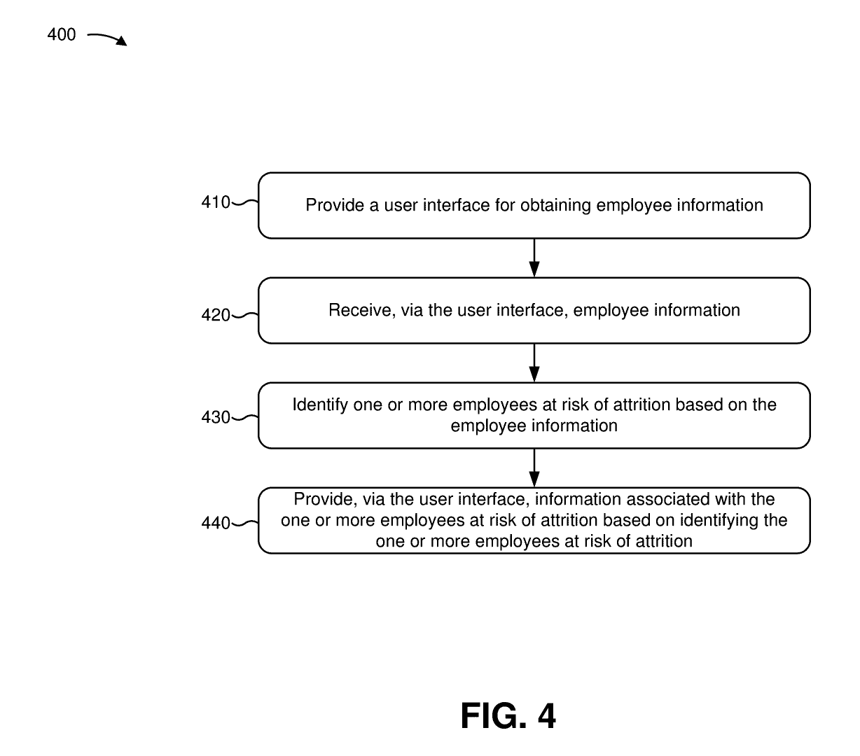

FIG. 4 is a flow chart of an example process 400 for automatically identifying employees at risk of attrition and providing information associated with increasing a likelihood of retaining the employees at risk of attrition. In some implementations, one or more process blocks of FIG. 4 may be performed by cloud server 220. In some implementations, one or more process blocks of FIG. 4 may be performed by another device or a group of devices separate from or including cloud server 220, such as user device 210.

As shown in FIG. 4, process 400 may include providing a user interface for obtaining employee information (block 410). For example, cloud server 220 may provide, via user device 210, the user interface for obtaining employee information. Employee information may include information regarding a current employee of a particular company, a former employee of the particular company, a current or former employee of another company, or the like. For example, cloud server 220 may provide a user interface with which to receive input regarding employee performance, such as an employee evaluation, a quantity of years at a particular job position, or the like. In this case, cloud server 220 may receive the employee information via user input of the employee information, user input of information identifying a data structure storing the employee information, or the like.

Additionally, or alternatively, cloud server 220 may provide a user interface to receive information regarding employee time and activity, such as an amount of vacation time utilized by the employee, an amount of billable time performed by the employee, a type of client for which the employee has performed work, a type of project to which the employee has been assigned, or the like. Additionally, or alternatively, cloud server 220 may provide a user interface to receive information associated with an employee working group, such as a peer group rating of an employee, employee information for other employees in the peer group of the employee, or the like. Additionally, or alternatively, cloud server 220 may provide a user interface to receive information regarding employee compensation (e.g., employee salary information, employee benefits information, etc.), employee training (e.g., a quantity of training programs attended by an employee, a quantity of certifications earned by an employee, etc.), employee travel, or the like.

In some implementations, cloud server 220 may automatically populate the user interface with information for the user. For example, cloud server 220 may obtain salary information for an employee, and may provide the salary information via the user interface for confirmation, modification, or the like. Additionally, or alternatively, cloud server 220 may locate one or more data structures storing employee information, and may provide information identifying the one or more data structures. For example, cloud server 220 may locate a data file storing employee evaluations for a particular year, and may provide information identifying the data file. In this way, cloud server 220 improves a user experience relative to the user being required to provide employee information manually. Moreover, based on automatically populating the employee information into the user interface cloud server 220 reduces a quantity of time during which computing resources are required to be assigned relative to requiring that employee information be populated manually.

In some implementations, cloud server 220 may provide the user interface to receive employee information based on failing to automatically obtain employee information. For example, cloud server 220 may determine that a data structure includes insufficient employee information from which to determine drivers of attrition, identify at-risk employees, or the like. In this case, cloud server 220 may provide the user interface to permit a user to provide employee information to facilitate determining drivers of attrition, identifying at-risk employees, or the like.

In some implementations, cloud server 220 may integrate one or more data security techniques when providing the user interface to receive the employee information. For example, cloud server 220 may establish protected data structures, passwords, user restrictions, data anonymization, or the like for employee information that is to be received via the user interface. In this case, cloud server 220 may require authentication from a user, prior to the user being provided access to employee information, information identifying at-risk employees, or the like. In this way, cloud server 220 ensures data security for employees of the company.

As further shown in FIG. 4, process 400 may include receiving, via the user interface, employee information (block 420). For example, cloud server 220 may receive, via user device 210 and the user interface, employee information regarding current employees of a company, former employees of the company, current or former employees of another company, or the like. In some implementations, cloud server 220 may receive information identifying a portion of the company from which at-risk employees are to be identified. For example, cloud server 220 may receive information identifying a common employment status for multiple employees (e.g., management employees, engineering employees, marketing employees, etc.), a common geographic location for multiple employees (e.g., Asia-based employees, England-based employees, California-based employees, etc.), a common business unit for multiple employees (e.g., a corporate business unit, a client development business unit, etc.), a demographic type of employee (e.g., female employees, employees under a particular age threshold, employees hired within a threshold number of years, etc.), or the like. In this case, cloud server 220 may process a subset of employee information relating to the portion of the company from which the at-risk employees are to be identified. In this way, cloud server 220 reduces processing and/or memory requirements based on processing the subset of employee information rather than processing employee information relating to all employees of the company.

In some implementations, cloud server 220 may receive information identifying one or more employees to exclude from an identification of at-risk employees. For example, cloud server 220 may receive information causing cloud server 220 to exclude an employee with a tenure at the company less than a particular quantity of years, an employee with a performance rating less than average among peers of the employee, an employee scheduled for retirement or managed attrition, an employee of a subcontracting company, an employee of a particular seniority level (e.g., an executive), a temporary employee, an intern employee, or the like. In this way, cloud server 220 reduces a quantity of employee information for processing when identifying at-risk employees (e.g., employee information relating to excluded employees), thereby reducing processing and/or memory utilization.

In some implementations, cloud server 220 may store information, received via the user interface, via one or more data structures. For example, cloud server 220 may locate and/or establish a secure data structure (e.g., a password protected data structure or the like) via which to store information regarding employees of the company. In some implementations, cloud server 220 may identify confidential information, and provide authentication protection for the confidential information. For example, cloud server 220 may identify information as salary information for a set of employees, and may store the salary information via a data structure with limited access. In some implementations, cloud server 220 may anonymize data. For example, cloud server 220 may apply one or more anonymization techniques (e.g., removing identifying information, assigning employee identifiers to replace identifying information, etc.) to protect data received via the user interface. In this case, cloud server 220 may require a user to provide authentication credentials before cloud server 220 provides access to portions of the employee information and/or results of processing employee information.

In some implementations, cloud server 220 may automatically obtain employee information. For example, cloud server 220 may identify one or more data structures storing employee information, and may obtain the employee information from the one or more data structures. Additionally, or alternatively, cloud server 220 may utilize a natural language processing technique to obtain employee information. For example, cloud server 220 may identify a human resources report regarding an employee written in natural language, and may obtain one or more attribute values regarding the employee (e.g., a salary attribute value, a performance review attribute value, etc.) based on parsing the human resources report. Similarly, cloud server 220 may receive information identifying a press release, a company handbook, an employee manual, a set of company policies, or the like, and may apply a natural language processing technique (e.g., a machine learning technique, a heuristic algorithm, etc.), to identify employee information included therein. In this way, cloud server 220 may reduce processing, memory utilization, power utilization, or the like relative to requiring a user to manually provide employee information.

In some implementations, cloud server 220 may automatically obtain a portion of employee information and may receive a portion of employee information via the user interface. For example, cloud server 220 may receive information identifying a set of employees via a user interface, and may automatically obtain salary information for the set of employees from a data structure, from applying a natural language processing technique to a natural language document, or the like. In this way, cloud server 220 automates a portion of obtaining employee information, thereby reducing computing relative to obtaining all information via manual entry by a user.

As further shown in FIG. 4, process 400 may include identifying one or more employees at risk of attrition based on the employee information (block 430). For example, cloud server 220 may identify one or more at-risk employees based on the employee information. In some implementations, cloud server 220 may identify the one or more at-risk employees based on identifying a set of drivers of attrition. For example, based on employee information regarding a set of past employees (e.g., past employees of the company, past employees of another company, etc.), cloud server 220 may determine the set of drivers of attrition that correspond to a likelihood of attrition exceeding a threshold. In this case, cloud server 220 may determine that a particular employee is associated with a particular driver of attrition, such as the particular employee's salary being less than coworkers of the particular employee, the particular employee being required to travel greater than a threshold number of days, or the like, and may determine that the particular employee has a likelihood of attrition greater than a threshold based on being associated with the particular driver of attrition.

In some implementations, cloud server 220 may utilize a model to identify the one or more at-risk employees and/or determine the set of drivers of attrition. For example, cloud server 220 may utilize a machine learning technique model, a heuristic model, a pattern matching model, a human resources model (e.g., a customized or proprietary model developed by a human resources department for a particular subset of employees, such as management employees, engineering employees, legal employees, etc.), or the like. In this case, cloud server 220 may utilize the model to process the employee information and identify the one or more at-risk employees and/or determine the set of drivers of attrition. In some implementations, cloud server 220 may obtain the model from storage. For example, cloud server 220 may generate a heuristic model for determining the set of drivers of attrition, and may store the model via a data structure for utilization in a response to a user request for information identifying the set of drivers of attrition.

In some implementations, cloud server 220 may generate a model to determine the set of drivers of attrition and/or the one or more at-risk employees. For example, when cloud server 220 determines to utilize a machine learning technique model, cloud server 220 may utilize a first portion of the employee information as a training set for identifying the set of drivers of attrition and/or predicting the one or more at-risk employees, and may utilize a second portion of the employee information as a validation set (e.g., for validating accuracy of identifying the set of drivers of attrition and/or predicting the one or more at-risk employees). In this case, cloud server 220 may apply the machine learning technique to a prediction set (e.g., current employees from which at-risk employees are to be identified) to identify the one or more at-risk employees.

In some implementations, cloud server 220 may determine that insufficient employee information, regarding a particular subset of employees from which to identify at-risk employees, is obtainable to determine the set of drivers of attrition. For example, when cloud server 220 is caused to determine drivers of attrition for employees of a particular country with fewer than a threshold quantity of employees, cloud server 220 may determine that insufficient information is present to accurately determine the drivers of attrition. In this case, cloud server 220 may provide a user interface with which to receive information identifying drivers of attrition, such as information identifying attributes, information identifying a human resources model for attrition, or the like.

In some implementations, cloud server 220 may identify one or more at-risk employees based on comparing employees of the company to past employees of the company or another company. For example, cloud server 220 may determine, based on a pattern matching technique, that a particular employee and a past employee are associated with a threshold similarity, and may determine that the particular employee is associated with a likelihood of attrition greater than a threshold based on the threshold similarity. Additionally, or alternatively, cloud server 220 may utilize a machine learning technique, an artificial intelligence technique, a heuristic technique, or the like to determine the similarity score.

In some implementations, cloud server 220 may identify a likelihood of attrition for a particular employee, and may identify the particular employee as an at-risk employee based on the likelihood of attrition. For example, cloud server 220 may determine that employee information associated with the particular employee (e.g., a salary, a quantity of vacation days, a performance evaluation, etc.) is associated with a particular likelihood of attrition, and may determine that the particular likelihood of attrition exceeds a probability threshold. Additionally, or alternatively, cloud server 220 may determine that the particular likelihood of attrition is greater than one or more other likelihoods of attrition associated with one or more other employees. For example, cloud server 220 may determine a set of likelihoods of attrition for a corresponding set of employees, and may select one or more employees from the set of employees based on the set of likelihoods of attrition (e.g., a threshold quantity of employees, such as a top 10 likelihoods of attrition or the like, a threshold percentage of employees with the top 10% of likelihoods of attrition or the like, etc.).

In some implementations, cloud server 220 may identify the likelihood of attrition for the particular employee based on a machine learning technique, a pattern matching technique, a heuristic technique, a human resources (i.e., partially manually generated) model, or the like. For example, cloud server 220 may utilize the machine learning technique to determine that a set of attributes of the particular employee (some of which are drivers of attrition) correspond to a particular likelihood of attrition.

As further shown in FIG. 4, process 400 may include providing, via the user interface, information associated with the one or more employees at risk of attrition based on identifying the one or more employees at risk of attrition (block 440). For example, cloud server 220 may provide, via user device 210 and the user interface, information identifying the one or more at-risk employees. In some implementations, cloud server 220 may provide, via user device 210 and the user interface, information identifying the set of drivers of attrition. For example, cloud server 220 may provide information identifying the set of drivers of attrition which correspond to a threshold likelihood of attrition.

Additionally, or alternatively, for a particular type of employee information, such as a performance evaluation with multiple performance grades, cloud server 220 may provide a risk of attrition associated with each grade (e.g., a high risk of attrition for employees scoring an ‘A’ or a ‘C’ on a performance evaluation, a medium risk of attrition for employees scoring a ‘B’ on a performance evaluation, a low risk of attrition for employees scoring a ‘D’ on a performance evaluation, etc.). Similarly, cloud server 220 may provide a risk of attrition associated with different quantities of travel time utilized by an employee (e.g., a high risk of attrition for an employee utilizing <1% or >25% of time for travel, a low risk of attrition for an employee utilizing between 10% and 15% of time for travel, etc.).

In some implementations, cloud server 220 may provide one or more attrition trends based on the set of attrition drivers. For example, cloud server 220 may provide information identifying a past attrition rate for a particular driver of attrition. In this case, when the driver of attrition is the performance evaluation of an employee, cloud server 220 may provide information identifying past attrition rates for each grade of the performance evaluation, information identifying a percentage of current employees associated with each grade of the performance evaluation, or the like. In this way, cloud server 220 may provide information for a user identifying historical data for a driver of attrition.

In some implementations, cloud server 220 may provide information identifying one or more recommendations for reducing a risk of attrition associated with an at-risk employee. For example, cloud server 220 may determine that a particular strategy (e.g., increasing salary, reducing employment hours, offering remote working capability, providing a gym membership, etc.), when applied to an employee associated with a particular driver of attrition (e.g., a particular grade in a performance evaluation) is associated with a particular reduction in the risk of attrition. In this way, cloud server 220 provides information identifying one or more strategies, which are customized for a particular employee, for reducing a risk of attrition with the particular employee, thereby saving costs relative to implementing the one or more strategies for all employees, for all at-risk employees, or the like.

In some implementations, cloud server 220 may provide information to a set of stakeholders associated with employee attrition. For example, cloud server 220 may automatically identify a particular stakeholder, such as an education manager associated with scheduling an educational program, a compensation manager associated with approving a salary increase, or the like. In this case, cloud server 220 may automatically provide a notification to the particular stakeholder identifying an at-risk employee and a corresponding recommendation (e.g., a recommended strategy) for reducing a risk of attrition. In some implementations, cloud server 220 may automatically implement the recommendation. For example, cloud server 220 may update an employee handbook associated with a particular at-risk employee identifying benefits being offered to the particular at-risk employee. Additionally, or alternatively, when cloud server 220 determines a strategy of setting up a meeting with a supervisor for an at-risk employee (e.g., to discuss an incentive being offered to the at-risk employee), cloud server 220 may automatically populate a calendar of the supervisor and the at-risk employee with the meeting. Similarly, cloud server 220 may automatically populate a set of calendars for a set of at-risk employees with entries associated with programs being offered for the set of at-risk employees (e.g., educational programs, social programs, etc.).

In some implementations, cloud server 220 may automatically update one or more data structures. For example, cloud server 220 may automatically update a compensation data structure to reflect a compensation increase for an at-risk employee. Similarly, cloud server 220 may automatically update a data structure storing work assignments with a set of work assignments selected for a particular at-risk employee. In this way, cloud server 220 may reduce network utilization relative to providing a first notification to a manager of at-risk employees, and the manager of at-risk employees being required to provide a second notification to a manager associated with maintaining the one or more data structures.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In this way, cloud server 220 reduces a likelihood of attrition for employees of a company thereby reducing costs of the company. Moreover, based on filtering the set of employees to a particular subset of employees from which to identify one or more at-risk employees, cloud server 220 reduces processing and/or memory utilization associated with identifying the one or more at-risk employees relative to utilizing employee information regarding all employees.

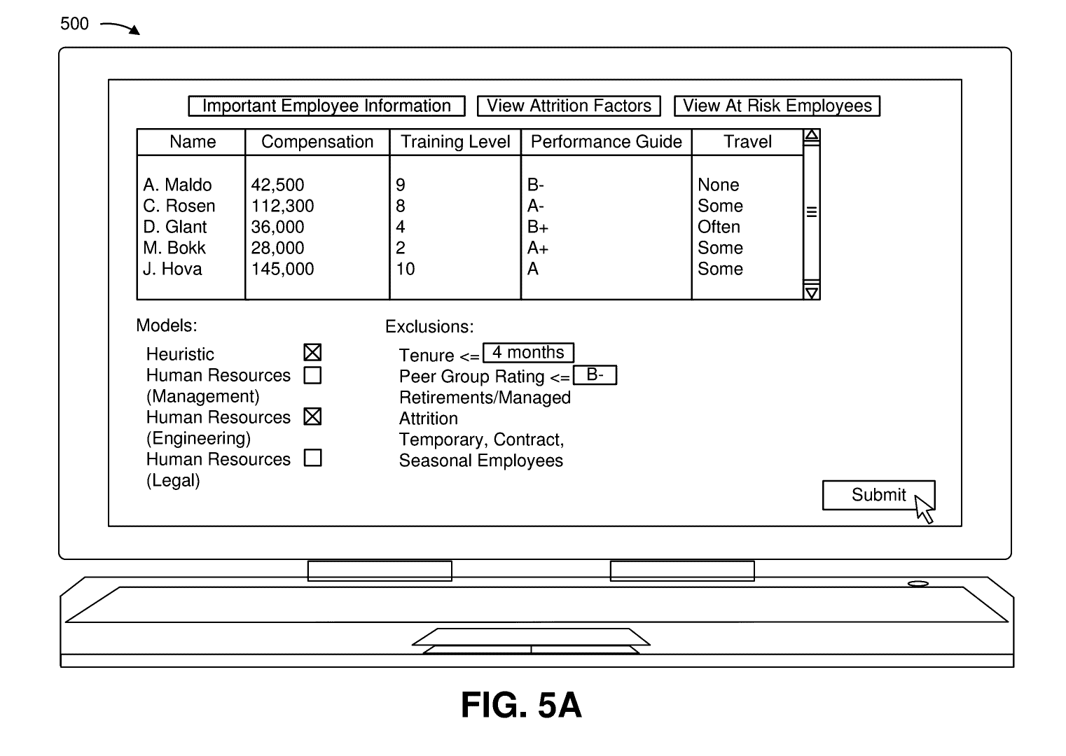

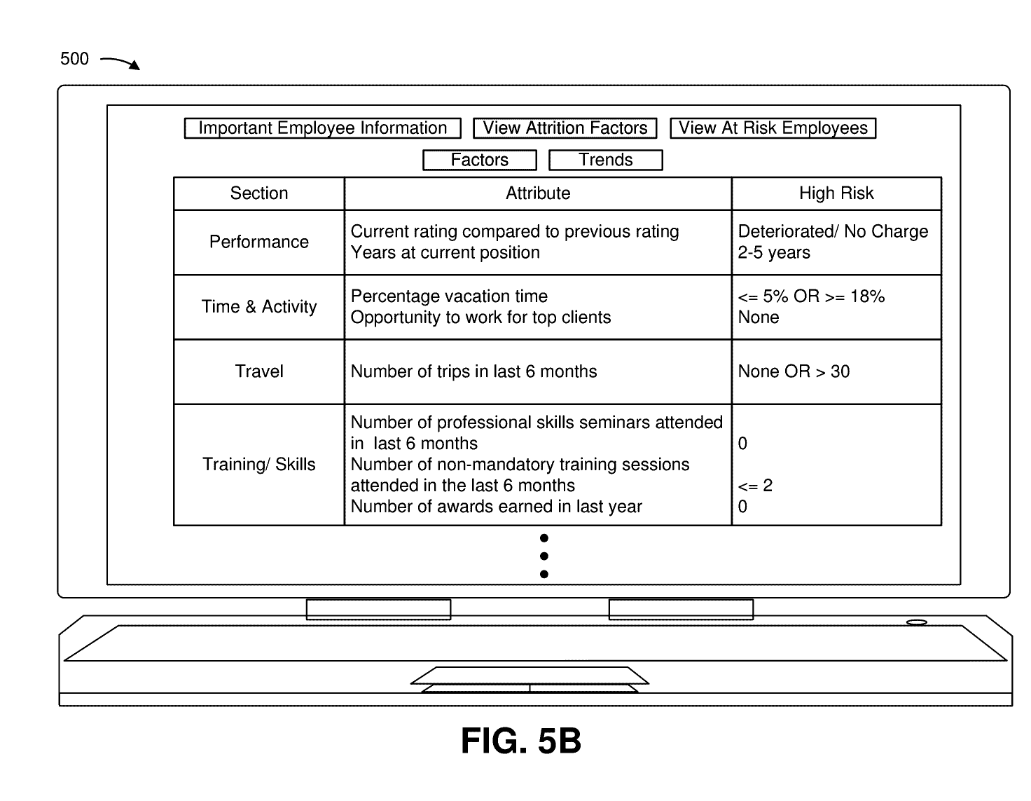

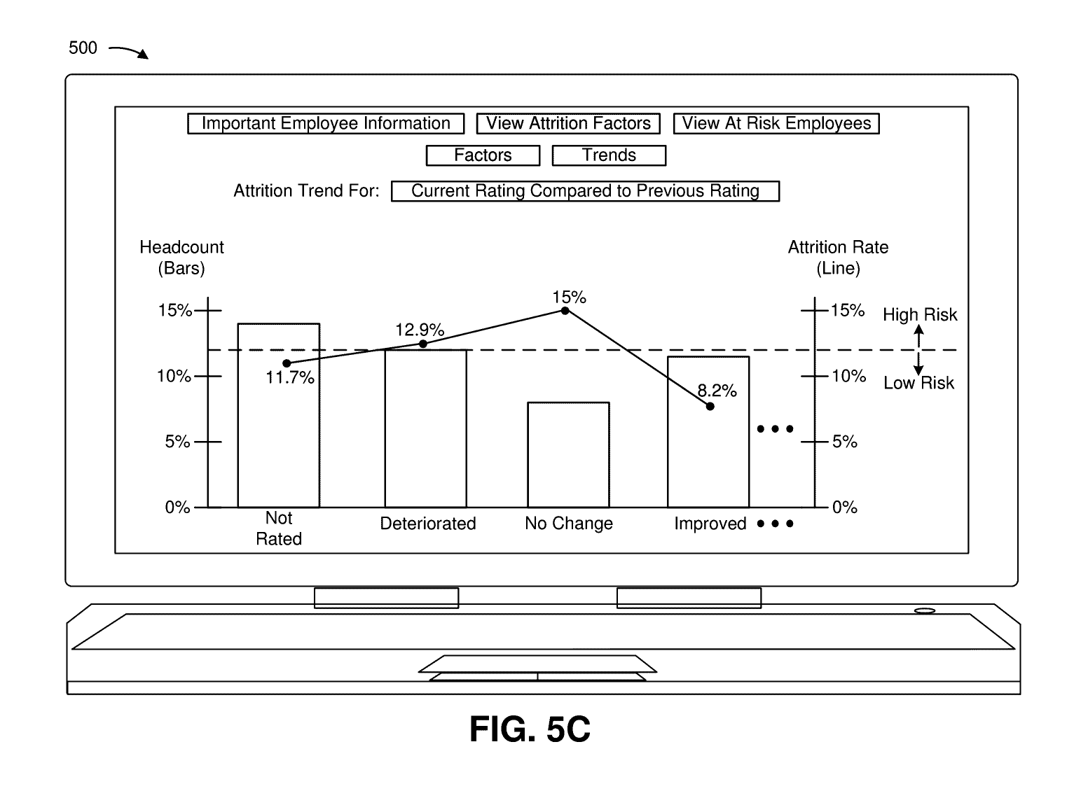

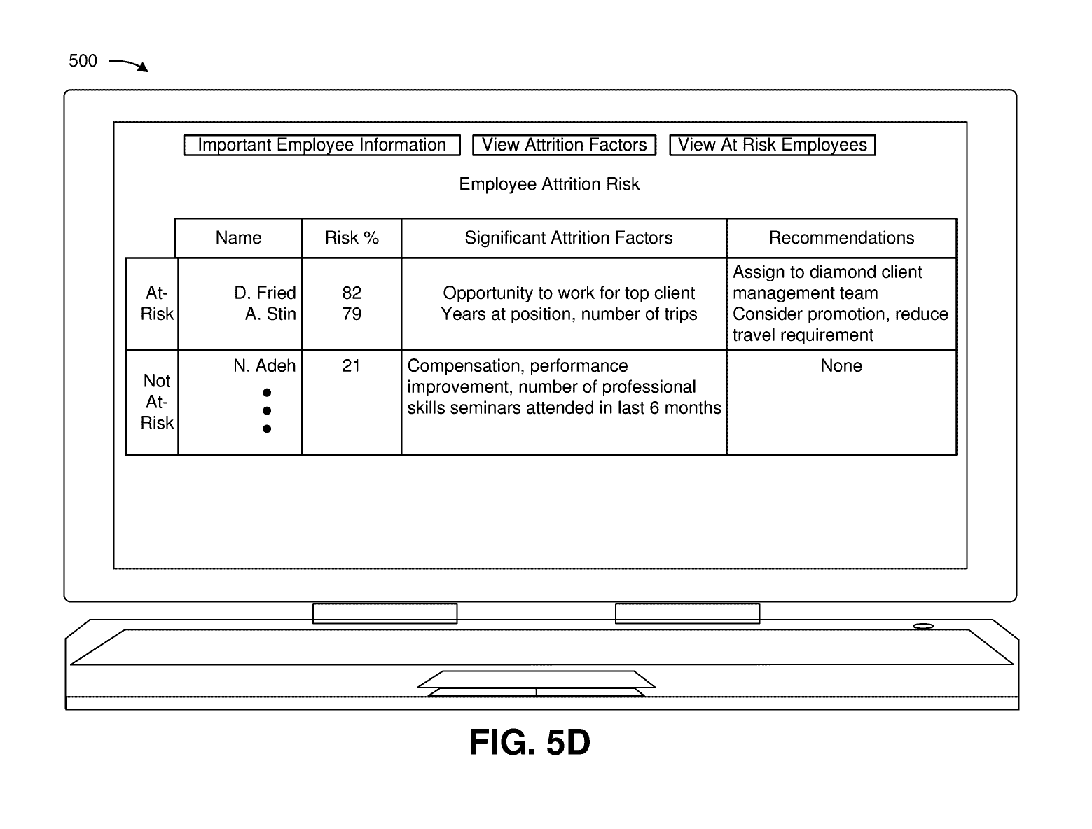

FIGS. 5A-5D are diagrams of an example implementation 500 relating to example process 400 shown in FIG. 4. FIGS. 5A-5D show an example of automatically identifying employees at risk of attrition and providing information associated with increasing a likelihood of retaining the employees at risk of attrition.

As shown in FIG. 5A, cloud server 220 causes user device 210 to display a user interface to receive employee information. Assume that a user inputs information identifying a data structure storing employee information. Cloud server 220 provides the employee information for display. For example, cloud server 220 provides employee identification information, salary information, training information, performance information, travel information, or the like. Assume that the user inputs information identifying a set of models to be utilized to identify the one or more at-risk employees (e.g., a heuristic model, a human resources model for engineering employees, etc.). Further assume that the user inputs information associated with selecting a portion of employees of a company from which to identify one or more at-risk employees. Cloud server 220 receives information identifying a set of employees to exclude from the portion of employees, such as employees associated with a tenure less than or equal to 4 months, employees with a peer group rating less than or equal to B−′, employees scheduled for retirement or managed attrition, temporary employees, contract employees, seasonal employees, or the like. Based on user interaction with a button, cloud server 220 is caused to determine a set of drivers of attrition based on the employee information.

As shown in FIG. 5B, cloud server 220 provides, via user device 210, a user interface identifying the set of drivers of attrition. Cloud server 220 provides information identifying a category of a particular driver of attrition (e.g., “Section”), such as a set of performance drivers of attrition, a set of time & activity drivers of attrition, a set of travel drivers of attrition, a set of training/skills drivers of attrition, or the like. Cloud server 220 provides information identifying a particular attribute for each driver of attrition that, when associated with an employee, corresponds to a threshold likelihood of attrition for the employee, such as having 2-5 years of experience at a current position without receiving a promotion, having had no opportunity to work with clients classified as top clients, being required to take either no business trips or over 30 business trips in the last 6 months, or the like.

As shown in FIG. 5C, cloud server 220 provides, via user device 210, a user interface identifying an attrition trend for a particular driver of attrition, such as a current performance evaluation rating compared with a previous performance evaluation rating. Cloud server 220 provides information identifying a historical attrition rate (e.g., determined based on employee information associated with a set of former employees at the company and current employees at the company) associated with each value for the particular driver of attrition and a percentage of current employees that correspond with each value.

As shown in FIG. 5D, cloud server 220 provides, via user device 210, a user interface associated with identifying at-risk employees and not-at-risk employees. Cloud server 220 provides information identifying employees, a risk of attrition for the employees, significant attrition factors for the employees, and/or recommendations regarding reducing a risk of attrition for the employees. Assume that cloud server 220 utilizes a 75% risk of attrition as a threshold for classifying an employee as an at-risk employee and providing a recommendation to reduce the risk of attrition. For a particular employee (e.g., “D. Fried”) identified as at-risk, cloud server 220 identifies a risk of attrition of 82%, which exceeds the threshold risk of attrition, identifies significant attrition factor (e.g., an attribute of not having had an opportunity to work for top clients), and provides a recommendation (e.g., assigning the first employee to a ‘diamond client management team’ to provide an opportunity to work for top clients). In contrast, for another employee (e.g., “N. Adeh”) identified as not at-risk, cloud server 220 identifies a risk of attrition of 21%, which fails to exceed the threshold risk of attrition, identifies a set of significant attrition factors, but based on the risk of attrition failing to exceed the threshold risk of attrition, cloud server 220 does not determine and provide a recommendation for reducing the risk of attrition, thereby reducing processing and/or memory requirements relative to determining and providing a recommendation for each employee of the company.

As indicated above, FIGS. 5A-5D are provided merely as an example. Other examples are possible and may differ from what was described with regard to FIGS. 5A-5D.

In this way, cloud server 220 utilizes employee information to determine a set of drivers of attrition and identify one or more at-risk employees and to generate recommendations for reducing a risk of attrition for the one or more at-risk employees. Based on processing employee information associated with a selected subset of employees and generating recommendations for at-risk employees, cloud server 220 reduces processing and/or memory requirements relative to utilizing employee information and generating recommendations for all employees.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned implementations are utilized to influence employment outcomes, it should be understood that such information shall be used in accordance with all applicable laws concerning non-discrimination of employees. Accordingly, it may be appropriate to modify an employment retention plan to ensure that there is no discrimination on the basis of race, color, national or ethnic origin, ancestry, age, religion or religious creed, disability or handicap, sex or gender, gender identity, sexual orientation, military or veteran status, genetic information, or any other characteristic protected under applicable law. Moreover, although implementations are described herein in terms of retention plans based on certain characteristics, other characteristics may be equally applicable.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive data from a user,
automatically evaluate the data to identify a set of attributes that are associated with classifying one or more data entries as being associated with a threshold risk;
automatically evaluate the data to generate, based on an attribute, of the set of attributes, associated with a data entry, of the one or more data entries, a recommendation associated with reducing a risk associated with the data entry, such that the risk does not exceed the threshold risk; and
provide, to the user, information identifying the recommendation.

2. The device of claim 1, where the set of attributes are a set of drivers of attrition;
and where the one or more processors, when automatically evaluating the data to identify the set of attributes, are to:
determine, based on employee information associated with a set of employees of a company, that employees associated with a particular attribute are associated with the threshold risk,
the threshold risk being a risk of attrition; and
determine that the particular attribute is included in the set of attributes based on determining that employees associated with the particular attribute are associated with the threshold risk.

3. The device of claim 1, where the one or more processors are further to:
receive a set of filtering criteria associated with identifying data entries of interest for which to determine one or more recommendations;
filter the data based on the set of filtering criteria to select a filtered subset of the data; and
where the one or more processors, when automatically evaluating the data to generate the recommendation, are to:
automatically evaluate the filtered subset of the data.

4. The device of claim 1, where the one or more processors are further to:
identify one or more stakeholders associated with implementing the recommendation; and
automatically provide information identifying the recommendation to the one or more stakeholders.

5. The device of claim 1, where the one or more processors are further to:
automatically identify the one or more data entries based on the set of attributes,
each data entry, of the one or more data entries, being associated with one or more attributes of the set of attributes,
the one or more data entries being included in a set of data entries,
the set of data entries including a plurality of data entries not associated with the threshold risk; and
provide information associated with identifying the one or more data entries.

6. The device of claim 1, where the one or more processors, when receiving the data from the user, are to:
provide a user interface; and
receive, via the user interface, information associated with identifying the data; and
obtain the data based on the information associated with identifying the data.

7. The device of claim 1, where the one or more processors, when providing the information identifying the recommendation, are further to:
generate a user interface; and
provide the information identifying the recommendation via the user interface.

8. A non-transitory computer-readable medium storing instructions, the instructions comprising:
one or more instructions that, when executed by one or more processors, cause the one or more processors to:
provide a user interface with which to receive information;
receive, via the user interface, information associated with selecting a subset of employees of a company from which to identify one or more employees at risk of attrition;
obtain employee information regarding employees of the company;
filter the employee information to select a subset of employee information relating to the subset of employees of the company;
identify the one or more employees at risk of attrition based on the subset of employee information,
the one or more employees at risk of attrition being determined to be associated with a risk of attrition that satisfies a threshold risk;
generate, for each employee of the one or more employees at risk of attrition, a corresponding recommendation for reducing the risk of attrition; and
provide, via the user interface, information identifying, for a particular employee of the one or more employees, the corresponding recommendation for reducing the risk of attrition.

9. The computer-readable medium of claim 8, where the one or more instructions, when executed by the one or more processors, further cause the one or more processors to:
receive, via the user interface, a selection of a model from which to determine one or more drivers of attrition,
the one or more drivers of attrition corresponding to attributes that, when associated with an employee of the company, correspond to the employee being associated with a risk of attrition that satisfies the threshold risk;
determine, based on the model, the one or more drivers of attrition; and
provide information identifying the one or more drivers of attrition.

10. The computer-readable medium of claim 9, where the one or more instructions, that cause the one or more processors to identify the one or more employees at risk of attrition, cause the one or more processors to:
determine that each employee, of the one or more employees, is associated with a driver of attrition of the one or more drivers of attrition; and
identify the one or more employees at risk of attrition based on determining that each employee, of the one or more employees, is associated with a driver of attrition of the one or more drivers of attrition.

11. The computer-readable medium of claim 9, where the one or more instructions, that cause the one or more processors to generate the corresponding recommendation, cause the one or more processors to:
generate the corresponding recommendation for the particular employee at risk of attrition based on a particular driver of attrition, of the one or more drivers of attrition, with which the particular employee is associated.

12. The computer-readable medium of claim 8, where the one or more instructions, that cause the one or more processors to provide the corresponding recommendation, cause the one or more processors to:
identify a set of calendar entries associated with the corresponding recommendation; and
automatically populate one or more calendars with the set of calendar entries.

13. The computer-readable medium of claim 8, where the one or more instructions, that cause the one or more processors to receive the information associated with selecting the subset of employees of the company, cause the one or more processors to:
receive information identifying employees that have a common geographic location, that have a common employment status, or that work for a common business unit; and
where the one or more instructions, that cause the one or more processors to filter the employee information, cause the one or more processors to:
filter the employee information to select employee information relating to the employees that have the common geographic location, that have the common employment status, or that work for the common business unit.

14. The computer-readable medium of claim 8, where the one or more instructions, when executed by the one or more processors, further cause the one or more processors to:
obtain other employee information regarding employees of one or more other companies,
a portion of the employees of the one or more other companies being former employees of the one or more other companies; and
where the one or more instructions, that cause the one or more processors to identify the one or more employees at risk of attrition, cause the one or more processors to:
identify the one or more employees at risk of attrition based on the other employee information regarding the employees of the one or more other companies.

15. A method, comprising:
determining, by a device, a set of drivers of attrition associated with a workforce of a company,
each driver of attrition, of the set of drivers of attrition, being associated with a threshold likelihood of attrition for an employee;
receiving, by the device, information identifying a portion of the workforce of the company from which to identify one or more employees at risk of attrition,
the portion of the workforce being less than the workforce;
identifying, by the device, a particular employee of the portion of the workforce of the company associated with a driver of attrition of the set of drivers of attrition;
determining, by the device, that the particular employee is associated with a likelihood of attrition that satisfies a threshold likelihood;
determining, by the device, a plurality of recommendations associated with reducing the likelihood of attrition for the particular employee such that the likelihood of attrition does not satisfy the threshold likelihood;
selecting, by the device, a particular recommendation of the plurality of recommendations; and
providing, by the device, information identifying the particular recommendation.

16. The method of claim 15, further comprising:
determining, by the device, that employee information associated with the particular employee is associated with a threshold similarity to employee information associated with a former employee of the company,
the former employee and the particular employee both being associated with the driver of attrition; and
where determining that the particular employee is associated with the likelihood of attrition that satisfies the threshold likelihood comprises:
determining that the particular employee is associated with the likelihood of attrition that satisfies the threshold likelihood based on determining that the employee information associated with the particular employee is associated with the threshold similarity to the employee information associated with the former employee of the company.

17. The method of claim 15, where the recommendation is associated with increasing compensation for the particular employee; and
where providing information identifying the particular recommendation comprises:
automatically altering a compensation data structure to increase compensation for the particular employee.

18. The method of claim 15, where the recommendation is associated with offering one or more fringe benefits to the particular employee; and
where providing information identifying the particular recommendation comprises:
updating a digital employee handbook associated with the particular employee to include information identifying the one or more fringe benefits.

19. The method of claim 15, where determining the set of drivers of attrition comprises:
evaluating, using a particular technique, employee information regarding a set of current and former employees of the company to identify attributes of the set of current and former employees that correspond to a threshold risk of attrition,
the particular technique including at least one of:
a natural language processing technique,
a heuristic technique,
a machine learning technique, or
an artificial intelligence technique.

20. The method of claim 15, where determining the set of drivers of attrition comprises:
determining that insufficient employee information, from which to determine the set of drivers of attrition, is obtainable regarding the portion of the workforce;
provide a user interface with which to receive information identifying the set of drivers of attrition based on determining that insufficient employee information is obtainable regarding the portion of the workforce; and
receive, via the user interface, information identifying the set of drivers of attrition based on providing the user interface.
